(19) United States
(12) Patent Application Publication
(10) Pub. No.: US 2023/0003236 A1
(43) Pub. Date: Jan. 5, 2023

(54) ACCUMULATOR SENSOR APPARATUS, SYSTEM, AND METHOD

(71) Applicant: Reel Power Licensing Corp., Oklahoma City, OK (US)

(72) Inventors: Nathan Schmidt, Houston, TX (US); Eston Huang, Houston, TX (US)

(21) Appl. No.: 17/940,248

(22) Filed: Sep. 8, 2022

Related U.S. Application Data
(63) Continuation of application No. 16/807,359, filed on Mar. 3, 2020, now abandoned.
(60) Provisional application No. 62/817,146, filed on Mar. 12, 2019.

(51) Int. Cl. F15B 21/10

(52) U.S. Cl. CPC F15B 21/10; E21B 33/064

(57) ABSTRACT

A sensor system for a dual bottle accumulator utilized with a subsea blowout preventer that monitors piston position with a position sensor in the hydraulic bottle, the gas pressure in the associated gas bottle with one or more pressure sensors, and sensors and remote actuators for associated valves.

### CROSS-REFERENCE TO RELATED APPLICATIONS

This application is a continuation of U.S. patent application Ser. No. 16/807,359, filed on Mar. 3, 2020, currently pending, in which priority is claimed from U.S. Provisional Application Ser. No. 62/817,146, filed on Mar. 12, 2019. Each of the applications listed above is hereby expressly incorporated herein by reference in their entirety.

### BACKGROUND OF INVENTION

### 1. Field of the Invention

In general, the present invention relates to a device, system, and method for subsea piston accumulators utilized with blowout preventers in oil and gas well operations. More particularly, the present invention provides an improved accumulator system by including pressure sensors for the gas bottle and a positioning sensor system for the piston in the hydraulic bottle of subsea accumulators.

### 2. Description of the Prior Art

As known in the art, a blowout preventer is a large, specialized valve or similar mechanical device, usually installed redundantly in stacks, used to seal, control, and monitor oil and gas wells. Blowout preventers were developed to cope with extreme erratic pressures and uncontrolled flow, often referred to as a formation kick, emanating from a well reservoir during drilling. Kicks can lead to a potentially catastrophic event known as a blowout. In addition to controlling the downhole pressure occurring in the drilled hole and the flow of oil and gas, blowout preventers are intended to prevent tubing such as drill pipe and well casing, tools, and drilling fluid from being blown out of the wellbore when a blowout threatens.

A typical subsea deep-water blowout preventer system includes hydraulic accumulators module that maintains the hydraulic fluid pressures needed to actuate valves on the blowout preventer. A subsea accumulator stores hydraulic fluid under pressure and must release the hydraulic fluid on demand to provide fast closure of the preventers and for cycling all critical components. The fluid to be pressurized is typically an oil-based product or a water based product with added lubricity and corrosion protection and are generally stored in what is referred to as the hydraulic bottle. Accumulators with a piston typically have a piston sliding up and down a seal bore to separate the fluid from the gas.

It is also known that a depth compensated piston accumulator must maintain a constant working fluid pressure in the working fluid chamber at any depth. At the surface, the nitrogen chamber is charged to a specific pressure, which exerts a force on top of the piston, which in turn pressurizes the working hydraulic fluid on the other side of the piston. As the accumulator is lowered deeper into the ocean, the ambient seawater pressure squeezes the hydraulic fluid in the bladder to the same pressure. This seawater pressure from the bladder is exerted on top of the piston in the seawater chamber. Essentially, all of the pressure force that is lost from the nitrogen due to the increased water pressure in very deep water is regained by directing that ambient pressure to the seawater chamber.

Blowout preventers are obviously extremely critical to well operations. Thus, there is a need for an apparatus, process, and or system that provides a system to monitor the pressure in the nitrogen tank and piston position in the hydraulic tank for use with a subsea piston accumulator. It is desirable to fill these needs with reliable technology that are affordable and attractive to accumulator operations associated with blowout preventers. The above discussed limitations in the prior art are not exhaustive. The current invention provides an inexpensive, time saving, more reliable apparatus, method, and system where the prior art fails.

### SUMMARY OF THE INVENTION

In view of the foregoing disadvantages inherent in the known types of accumulators utilized with blowout preventers now present in the prior art, the present invention provides a new and improved apparatus, system, and method of use that provides better accumulator performance. As such, the general purpose of the present invention, which will be described subsequently in greater detail, is to provide a new and improved sensor system for use with subsea piston accumulators for blowout preventers, which has all the advantages of the prior art devices and none of the disadvantages.

It is, therefore, contemplated that the present invention is an apparatus, system, and method for improved subsea piston accumulators by providing a first pressure sensor at the top of an accumulator nitrogen bottle and a second pressure sensor at the bottom. This may provide accurate information on the bottle's performance as well as a warning if pressures are too high or too low. It is also contemplated to provide a piston positioning sensor in the hydraulic bottle for determining the piston position relative to function. This may also provide a warning if the position of the piston is not optimal.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved piston accumulator apparatus, system, and method for use in subsea piston accumulators.

Furthermore, an object of the present invention is to provide a new and improved piston accumulator apparatus, system, and method, which allows for knowing the position of the piston in the hydraulic bottle.

Another object of the present invention is to provide a new and improved piston accumulator apparatus, system, and method, which may include a one or more pressure sensors in the nitrogen bottle

It is a further object of the present invention to provide a new and improved piston accumulator bladder apparatus, system, and method, which is of a durable and reliable construction and may be utilized in numerous types of piston accumulators.

An even further object of the present invention is to provide a new and improved piston accumulator bladder apparatus, system, and method, which is susceptible to a low cost of installation and labor, which accordingly is then susceptible to low prices of sale to the consuming industry, thereby making such a system economically available to those in the field.

Still another object of the present invention is to provide a new and improved piston accumulator bladder apparatus, system, and method, which provides all of the advantages of the prior art while simultaneously overcoming some of the disadvantages normally associated therewith.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS, GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices.

FIG. 1 is a general illustration of a preferred embodiment in accordance with the invention.

### DETAILED DESCRIPTION OF INVENTION

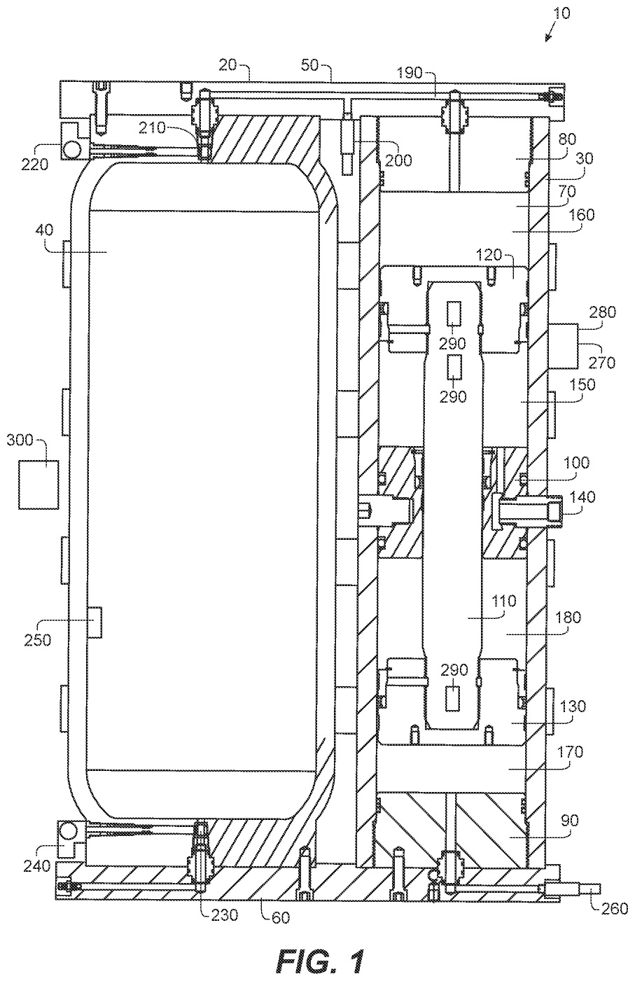

Referring to the illustrations, drawings, and pictures, and to FIG. 1 in particular, reference character 10 generally designates a new and improved piston accumulator apparatus, system, and method of using same constructed in accordance with the present invention. Invention 10 is generally used in oil and gas well operations such as but not limited to blowout preventers and may be utilized in other operations not associated with oil and gas drilling operations. For purposes of convenience, the reference numeral 10 may generally be utilized for the indication of the invention, portion of the invention, preferred embodiments of the invention and so on. Invention 10 may also include a new and improved accumulator apparatus, system, and method as well as new and improved blowout preventer apparatus, system, and method.

Referring now to FIG. 1, a dual bottle accumulator 20 is shown with a hydraulic bottle 30, a gas bottle 40, an upper mounting plate 50, and lower mounting plate 60. Hydraulic bottle 30 comprises a cylinder 70, an upper bulkhead 80, and lower bulkhead 90, a center bulkhead 100, a piston rod 110, an upper piston 120, and a lower piston 130.

Porting pin 140 is ported to chamber 150 for receiving and dispensing working fluid and which is pressurized as a function of the nitrogen pressure inside upper chamber 160. Upper chamber 160 has gas supply such as but not limited to nitrogen provided from bottle 40.

Lower chamber 170 has atmospheric pressure or is functionally a vacuum. Chamber 180 has seawater environmental pressure. Chamber 150 has working fluid within which is pressurized as a function of the nitrogen pressure within lower chamber 160 and the environmental pressure within chamber 180.

### Pressure Sensor System

Cylinder 70 is in communication with bottle 40 via porting 190, which may include a first pressure transducer 200. Bottle 40 may have a top valve 210 activated by rotary actuator 220 and a bottom valve 230 activated by rotary actuator 240. Valves 210 and 230 may be ball valves although other valves are contemplated such as but not limited to globe, plug, needle, gate and so forth.

First pressure transducer 200 may be provided to determine the pressure of the gas in bottle 40 and upper chamber 160. It is also contemplated to provide a pressure sensor 250 inside bottle 40. This would allow the ability to measure when valve 210 is closed. It is also contemplated to provide a second pressure transducer 260 to measure pressure in lower chamber 170.

### Piston Position Sensor

It is contemplated to provide a piston position sensor system 270, which may include a sensor 280 in communication with piston rod 110. It is contemplated that sensor 280 may generally be a receiver and piston rod 110 may be fitted with transponder(s) 290. Invention 10 contemplates but is not limited to sensor 280 being RFID, ultrasonic, magnetic, inductive, and or combinations thereof.

### Monitoring System

Invention 10 contemplates providing a monitoring and display system 300 that may monitor and display remotely the readings of pressure transducer 200, pressure transducer 250, pressure transducer 260, sensor 280, and so forth. It is also contemplated monitoring system 300 may also provide remote control of top valve 210 rotary actuator 220 and bottom valve 230 rotary actuator 240 and or indicate open/close status. Monitoring system 300 may include displays, be in communication with a master well controller, provide wired and or wireless connection, and so forth.

The current invention contemplates a subsea piston accumulator utilized with blowout preventers in oil and gas well operations comprising: a hydraulic bottle, having a cylinder, an upper bulkhead, and a lower bulkhead, a center bulkhead, a piston rod centered in said center bulkhead having an upper piston, a lower piston wherein said upper bulkhead and said upper piston define an upper chamber and said lower bulkhead and said lower piston define a lower chamber wherein said lower chamber has a second pressure transducer to measure pressure in said lower chamber; a gas bottle having a chamber for holding gas, a top valve controlled by a top rotary actuator for opening and closing said top valve, a bottom valve controlled by a bottom rotary actuator for opening and closing said bottom, and a pressure sensor in said chamber to measure pressure in said chamber; a port between said gas bottle and said upper chamber of said cylinder wherein said port has a first pressure transducer for measuring pressure of upper chamber of said cylinder and said chamber of said gas bottle; a piston position sensor system having a receiving sensor mounted on said hydraulic bottle, a transponder mounted on said piston rod, and wherein said receiver sensor and said transponder are adapted to provide a position of said piston rod in said cylinder; and a monitoring and display system in communication with said first pressure transducer, said pressure sensor, said second pressure transducer, said receiving sensor, said transponder, said top rotary actuator of said top valve, said bottom rotary actuator of said bottom valve, and wherein said monitoring and display system is adapted to open and close respectively said top valve and said bottom valve as desired.

Changes may be made in the combinations, operations, and arrangements of the various parts and elements described herein without departing from the spirit and scope of the invention. Furthermore, names, titles, headings, and general division of the aforementioned are provided for convenience and therefore, should not be considered limiting.

What is claimed is:

1. A subsea piston accumulator utilized with blowout preventers in oil and gas well operations comprising:
a hydraulic bottle, having a cylinder, an upper bulkhead, and a lower bulkhead, a center bulkhead, a piston rod centered in said center bulkhead having an upper piston, a lower piston wherein said upper bulkhead and said upper piston define an upper chamber and said lower bulkhead and said lower piston define a lower chamber wherein said lower chamber has a second pressure transducer to measure pressure in said lower chamber;
a gas bottle having a chamber for holding gas, a top valve controlled by a top rotary actuator for opening and closing said top valve, a bottom valve controlled by a bottom rotary actuator for opening and closing said bottom, and a pressure sensor in said chamber to measure pressure in said chamber;
a port between said gas bottle and said upper chamber of said cylinder wherein said port has a first pressure transducer for measuring pressure of upper chamber of said cylinder and said chamber of said gas bottle;
a piston position sensor system having a receiving sensor mounted on said hydraulic bottle, a transponder mounted on said piston rod, and wherein said receiver sensor and said transponder are adapted to provide a position of said piston rod in said cylinder; and
a monitoring and display system in communication with said first pressure transducer, said pressure sensor, said second pressure transducer, said receiving sensor, said transponder, said top rotary actuator of said top valve, said bottom rotary actuator of said bottom valve, and wherein said monitoring and display system is adapted to open and close respectively said top valve and said bottom valve as desired.
